(19) United States
(12) Patent Application Publication
(10) Pub. No.: US 2024/0084865 A1
(43) Pub. Date: Mar. 14, 2024

(54) Method for Producing a Braking Element and Braking Element

(71) Applicant: C4 Laser Technology GmbH, Freital (DE)

(72) Inventors: Tilo Steinmeier, Pohrsdorf (DE); Rene Bischoff, Dresden (DE)

(21) Appl. No.: 18/272,809

(22) PCT Filed: Jan. 18, 2021
(86) PCT No.: PCT/EP2021/050903

§ 371 Date: Jul. 18, 2023

(51) Int. Cl. F16D 65/12; F16D 65/00

(52) U.S. Cl. CPC F16D 65/127; F16D 65/0025; F16D 2200/0047

(57) ABSTRACT

The present invention relates to the field of automotive engineering and industrial plant engineering and concerns a method for producing braking elements and braking elements produced in this manner. The problem according to the invention consists in specifying a method and a braking element having improved wear and corrosion protection and a larger layer thickness of the frictional surface and which can be produced time- and cost-effectively. The problem is solved by a braking element which has at least one metallic main element having a frictional surface applied on a formed surface region, which frictional surface is a prefabricated layer of a metallic semi-finished product which is integrally connected to the metallic main element by means of a joining technique. The problem is also solved by a method in which the frictional surface is formed by at least one layer of a metallic semi-finished product and same is integrally connected to the metallic main element by means of a joining technique. The braking elements according to the invention can be used for example in vehicles, industrial plant or wind turbines.

### CROSS REFERENCE TO RELATED APPLICATIONS

This application is the U.S. national stage of International Application No. PCT/EP2021/050903, filed on 2021 Jan. 18.

### BACKGROUND

The present invention relates to the field of vehicle technology and of industrial plant technology and relates to a method of producing a braking element and to braking elements produced in this way. The braking elements of the invention may be used, for example, in vehicles, industrial plants or wind turbines.

Conventional braking elements in vehicles and in industrial applications are designed, for example, as a brake disk or brake drum in one-piece form made from a metallic or ceramic material or as a composite brake disk or multipart brake disk composed of one or more metallic or ceramic materials.

Braking elements have multiple functional regions. For instance, brake disks in motor vehicles are secured to the front and rear axles and, for this purpose, have a planar contact surface which is in contact firstly with the wheel rim and secondly with the wheel bearing. The entire brake disk is connected via the contact surface by means of wheel bolts. Wind turbines, industrial plants and power plants also have braking elements which, for example, are pressed onto a rotor shaft or connected thereto in some other way.

In addition, braking elements have regions with friction surfaces via which the braking action is implemented in association with rubbing brake linings.

For better dissipation of the heat that arises, brake disks may take the form, for example, of internally ventilated disk brakes. For this purpose, they have, between the friction surfaces, ventilation ducts in different geometries that suck in air, the air flow through the disk brake, dissipate heat and hence ensure the cooling of the brake disk.

Braking elements in the prior art, either in the region of the friction surfaces and/or in the region of the ventilation ducts, are provided with short-term protection from corrosion or with long-term protection from corrosion, with or without a hard coating. Short-term protection from corrosion protects the braking element from corrosion only for a short period of time, especially in order to prevent corrosion until the brake system is put to use.

The prior art discloses various solutions for protecting brake disks from corrosion and wear.

DE 20 2018 107 169 U1 discloses a coating, especially for brake disks, brake drums and clutch plates, having a first layer comprising a metal-based material containing less than 20% by weight of tungsten carbide or other carbides, and a second layer which is applied to the first layer and comprises a tungsten carbide-containing material that contains 20% by weight to 94% by weight of tungsten carbide, wherein the first layer and the second layer are thermally sprayed layers.

DE 20 2018 102 703 U1 discloses a braking element for a vehicle, having a main body that has a surface formed by roughening as friction surface and a coating applied to the friction surface by means of a thermal spraying method after roughening.

Additionally known from DE 102 03 507 A1 is a brake disk for a vehicle, comprising a main body made of a metallic material, especially gray iron, having at least one friction surface with a coating of a hard material, wherein the main body beneath the coating has a removed material thickness in the direction axially parallel to the axis of the brake disk, wherein the main body has a removed material thickness in the direction axially parallel to the axis of the brake disk of about the layer thickness of the coating, or up to +/−20% more or less, preferably +/−10%, based on the layer thickness of the coating.

And also known from DE 10 2014 008 844 A1 is a brake disk for a motor vehicle, comprising a substrate, especially a gray iron substrate, at least one friction surface formed on the substrate and at least one outer layer applied at least to the at least one friction surface, wherein the outer layer is harder and thinner than the substrate, and wherein depressions that do not penetrate the outer layer and/or color changes have been introduced in the outer layer.

A disadvantage of the known solutions is that the protection from corrosion and wear is applied to the main body of the braking element only superficially in the region of the friction surfaces and is rubbed away immediately after the first braking operations, such that the friction surface undergoes corrosion after a short period of time and, as a result of corrosion processes, directly damage the base material. Specifically in the case of electrical vehicles or hybrid vehicles, for example, a significantly smaller number of braking operations is undertaken. As a result, the friction surfaces are stressed to a lesser degree and initiation of corrosion is not eliminated. Such initiations of corrosion can inevitably lead to malfunctions. Malfunctions are manifested by noise problems and in the extreme case can lead to a loss of braking power. Moreover, a further disadvantage is that the corrosion that occurs in the region of the friction surfaces can cause them to wear more quickly.

A further disadvantage is that the layers achievable by diffusion processes have insufficient layer thickness to compensate for the tolerances that exist in the conventional manufacturing process without again having to remove a considerable portion of the layer thickness which is low in any case, in order to establish the manufacturing tolerances of offset, friction band thickness and true running.

Another disadvantage is the high material costs and manufacturing costs of cemented carbide-coated brake disks, coated, for example, with layer systems based on carbides such as tungsten carbide, chromium carbide or boron carbide, for example. The expenditure of energy even for production of the added materials and the material efficiency of the known coating methods, and also the high expenditure of thermal energy for melting the materials in the coating operation and the introduction of energy into the substrate, cause high production costs for the braking element to be coated.

### SUMMARY

It is an object of the present invention to specify a method of producing braking elements, and to specify braking elements produced in such a way with which the aforementioned disadvantages of the prior art are eliminated.

The object is achieved by the invention specified in the claims. Advantageous configurations of the invention are the subject of the dependent claims, and the invention also includes combinations of the individual dependent claims in the sense of an “and” linkage, provided that they are not mutually exclusive.

The object is achieved by a method of producing a braking element having at least one metallic main body having at least one surface region for forming a friction surface, in which at least one layer of a metallic semifinished product is positioned at least partly on the surface region intended for forming of the friction surface and is subsequently cohesively bonded to the metallic main body by joining methods.

### DETAILED DESCRIPTION

Advantageously, the position of the metallic semifinished product is essentially completely on the surface of the metallic main body provided as friction surface.

It is advantageous when there are two or more layers of the metallic semifinished product.

There are also advantageously multiple layers of the metallic semifinished product having the same or different layer thickness.

And also advantageously, the two or more layers are cohesively bonded to the metallic main body and/or to one another in one or more method steps by joining methods.

In an advantageous configuration of the method, there is at least one layer of the metallic semifinished product consisting of two or more segments.

Also advantageously, there are layers and/or segments of a layer composed of different materials, shapes and/or layer thicknesses, where, particularly advantageously, the segments are in the form of circular, oval, polygonal and/or freeform-shaped platelets.

It is additionally advantageous when the positioning of the layer formed from segments is followed by positioning of an Al-based alloy at least atop that layer, then a thermal treatment of the braking element is conducted, such that a diffusion structure at least composed of the layer formed from segments and the Al-based alloy is formed.

Advantageously, the at least one layer of the metallic semifinished product is cohesively bonded to the metallic main body by magnetic pulse welding, soldering, roll cladding, ultrasound welding, friction welding and/or modifications thereof.

And also advantageously, there is a final mechanical processing of the surface, at least of the friction surface, of the braking element.

The object of the invention is achieved by a braking element having at least one metallic main body having a friction surface applied to a surface region formed, which is a prefabricated layer of a metallic semifinished product cohesively bonded to the metallic main body by joining methods.

Advantageously, the at least one layer is composed of stainless steel, a metal matrix composite, ceramic matrix composite, cermet, cemented carbide, Glidcop and/or a material from the material class of the alum inides.

Also advantageously, the friction surface has a layer thickness of 0.1 mm to 4.0 mm.

In an advantageous configuration, there is a joining zone composed of and/or between the metallic main body and the layer of the metallic semifinished product of between 1 μm and 50 μm.

In a further advantageous configuration of the braking element, the friction surface is formed from two or more layers.

Likewise advantageously, the layers are composed of different materials, shapes and/or layer thicknesses.

In an advantageous configuration, at least one layer of the metallic semifinished product is formed from segments, where, particularly advantageously, the segments are circular, oval, polygonal and/or freeform-shaped platelets.

It is additionally advantageous when at least the friction surface has wear recognition features, where, particularly advantageously, the wear recognition features are surface depressions and/or color substances.

The present invention has for the first time succeeded in producing braking elements having improved antiwear and anticorrosion properties, the friction surface of which has a high layer thickness. Moreover, a time- and cost-efficient production process is provided.

In the context of the invention, a braking element shall be understood to mean a component in the form of a brake disk or brake drum, consisting of a metallic main body and having different functionalized regions such as friction surfaces in a diametric arrangement, a contact surface for securing the braking element to an axle or shaft, or else ventilation channels formed by lands.

A metallic main body in the context of the invention shall be understood to mean the brake disk or brake drum formed with the functionalized regions, produced from steel, gray iron and/or aluminum.

Friction surfaces in the context of the invention shall be understood to mean a single- or double-sided disk-shaped face by which the braking action is achieved in interaction with fitting brake linings.

A metallic semifinished product in the context of the invention shall be understood to mean a material that may have metallic constituents only to a partial degree or else may be entirely in metallic form. A metallic semifinished product may advantageously be a stainless steel, a metal matrix composite, ceramic matrix composite, cermet, cemented carbide, Glidcop and/or a material from the material class of the alum inides.

The present invention has for the first time succeeded in providing a brake disk or brake drum having improved anticorrosion and antiwear properties, which has been produced by the applying of a layer of a metallic semifinished product on the metallic main body, wherein the friction surface is formed by at least one layer of the metallic semifinished product and this has been cohesively bonded to the metallic main body by a joining method. The improved antiwear and anticorrosion properties are achieved at least in the region of the friction surfaces of the braking element, and the region of the contact surface and/or the ventilation channels may also have the wear protection and corrosion protection of the invention.

This is achieved by a method of producing a braking element in which the desired friction surface is formed by positioning at least one layer of a metallic semifinished product at least partly at least on the surface of the metallic main body which is intended as friction surface.

What is essential is that the at least one layer of the metallic semifinished product is subsequently cohesively bonded to the metallic main body by a joining method. The cohesive joining of the at least one layer of the metallic semifinished product and the metallic main body forms a joining zone that advantageously has a width of 1 μm to 50 μm.

The cohesive joining has the advantage that a uniform cohesive bond of metallic semifinished product and metallic main body is implemented, which achieves improved binding of the friction surface to the metallic main body. In addition, improved thermal conduction properties and bond strengths between metallic main body and friction surface are achieved, which leads to a longer service life of the braking element with improved wear protection and corrosion protection.

The already prefabricated metallic semifinished product may be a stainless steel, a metal matrix composite, ceramic matrix composite, cermet, cemented carbide, Glidcop and/or a material from the material class of the alum inides.

Particularly inexpensive and rapid joining methods are advantageously magnetic pulse welding, soldering, roll cladding and/or friction welding, and the specialized modifications thereof, for example laser-assisted roll cladding.

In order to provide a greater effective friction area, it is advantageous when the layer of the metallic semifinished product is positioned essentially completely on the surface of the metallic main body intended as friction surface. This may be required in particular for larger and heavier vehicles with an elevated requirement for breaking force, whereas only partial positioning of a layer of the metallic semifinished product on the surface of the metallic main body intended as friction surface may be implemented for vehicles having lower braking requirements, for example owing to recuperation in electrical vehicles.

It is also conceivable that, advantageously, there are two or more layers of a metallic semifinished product that collectively form the layer thickness of the friction surface of the braking element. It is possible here for there to be layers having the same or different material, different layer thickness within a layer or else with different layer thicknesses of the layers from one another, and these are cohesively bonded to the metallic main body and to one another in one or more method steps by joining methods.

For simplification of the joining method for cohesive bonding of the layer of the metallic semifinished product of the metallic main body, it is advantageous when at least one layer of the metallic semifinished product is formed by individual segments. The arrangement of individual segments makes it possible, for example, to create a surface-structured friction surface by, for example, spacing apart the segments to form gaps, into which an Al-based alloy can subsequently be introduced in an advantageous manner. Such surface structures may, for example, be gap-like depressions that extend up to the metallic main body, which lead to improved discharge of heat and abraded material from the friction surface and hence improve the performance of the braking element.

A further advantage of the arrangement of segments of a layer of the metallic semifinished product is that the cohesive joining method can be configured in a more time- and cost-efficient manner since a higher energy input per unit area is enabled, which leads to faster cohesive bonding of the segments to the metallic main body. In addition, it is possible in a simple manner to create surface structures that are advantageous, for example, for thermal characteristics and the outward transportation of fine dust.

In an advantageous configuration of the segments of a layer, it may be the case that the segments are circular, oval, polygonal and/or freeform-shaped platelets that are positioned on the metallic main body or on a layer and cohesively bonded thereto. The use of platelets has the advantage that the friction surface can be functionalized in regions, for example, via a different selection of material or number of platelets, and individualized in terms of thermal properties.

It is particularly advantageous when the braking element, before the positioning of at least one layer of the metallic semifinished product, is preheated to a temperature of 250° C. to 650° C. under protective gas atmosphere. It has been found that, in the case of a temperature above 200° C., unwanted oxidation products are normally formed in the course of preheating, but these are prevented by the use of a protective gas atmosphere.

Dispensing with the use of protective gas in the preheating of the braking element is surprisingly possible when the preheating temperature is set only at 150° C. to 200° C.

The friction surface of the braking element produced in accordance with the invention, by virtue of the at least one positioned layer of the metallic semifinished product, advantageously has a layer thickness of 0.1 mm to 4.0 mm, particularly advantageously a layer thickness of 0.3 mm to 1.5 mm.

A final mechanical processing operation can correct any possible thermal warpage of the friction surface and of the braking element in a simple manner, without removing the improved anti wear and anti corrosion properties and reducing the required layer thickness of the friction surface. The final mechanical processing operation achieves the effect that an additional operation to eliminate imbalances can be dispensed with.

The braking element of the invention, which has at least one layer of the metallic semifinished product at least in the region of the friction surfaces, eliminates this disadvantage since the exceptional hardness of 350 HV [0.3] to 850 HV [0.3] prevents the brake linings from running into the friction surfaces.

The thermally initiated diffusion of the Al-based alloy into the cast material or steel material, in the case of the connecting lands formed for the ventilation channels, makes it possible for the connecting lands to have a smaller wall thickness.

### DETAILED DESCRIPTION OF THE PREFERRED EMBODIMENTS

The invention is elucidated in detail hereinafter by two examples.

### Example 1

An internally ventilated vehicle brake disk made from gray iron is provided, having a hardness of 200-250 HV, averaging 211 HV. The brake disk has two friction surfaces in a diametrically opposite arrangement, and a contact surface for the securing of the brake disk on an axle. The two friction surfaces are connected by ventilation channels formed in the manner of lands. Using corundum (99.81% Al₂O₃, 0.1% Na₂O, 0.04% TiO₂, 0.02% SiO₂, 0.03% Fe₂O₃) and employing a nitrogen protective gas atmosphere, the surfaces of the two friction surfaces are mechanically processed twice at an angle of 45°, in and counter to the direction of rotation of the brake disk, and hence soiling, grease and oils, and also iron oxides, are removed in order to provide improved conditions for subsequent cohesive bonding of the metallic main body to a first layer of a semifinished product.

Subsequently, a first circular layer of a band material made of iron aluminide is positioned on the metallic main body in the region of the friction surfaces provided, and cohesively bonded to the metallic main body by means of magnetic pulse welding. Subsequently, a circular second layer of a band material made of iron aluminide consisting of a total of 6 identical segments is positioned on the first layer. The segments are spaced apart from one another with a gap width of 1 mm and in each case cohesively bonded by magnetic pulse welding to the first circular layer of stainless steel. The circular first layer and the segmented second layer each have a layer thickness of 0.55 mm, so as to form a friction surface having a layer height of 1.1 mm.

1. A method of producing a braking element having at least one metallic main body having at least one surface region for forming a friction surface, in which at least one layer of a metallic semifinished product is positioned at least partly on the surface region intended for forming of the friction surface and is subsequently cohesively bonded to the metallic main body by joining methods.

2. The method as claimed in claim 1, in which the layer of the metallic semifinished product is positioned essentially completely on the surface of the metallic main body provided as friction surface.

3. The method as claimed in claim 1, in which there are two or more layers of the metallic semifinished product.

4. The method as claimed in claim 1, in which there are multiple layers of the metallic semifinished product having the same or different layer thickness.

5. The method as claimed in claim 1, in which the two or more layers are cohesively bonded to the metallic main body and/or to one another in one or more method steps by joining methods.

6. The method as claimed in claim 1, in which there is at least one layer of the metallic semifinished product consisting of two or more segments.

7. The method as claimed in claim 1, in which there are layers and/or segments of a layer composed of different materials, shapes and/or layer thicknesses.

8. The method as claimed in claim 7, in which the segments are in the form of circular, oval, polygonal and/or freeform-shaped platelets.

9. The method as claimed in claim 6, in which the positioning of the layer formed from segments is followed by positioning of an Al-based alloy at least atop that layer, then a thermal treatment of the braking element is conducted, such that a diffusion structure at least composed of the layer formed from segments and the Al-based alloy is formed.

10. The method as claimed in claim 1, in which the at least one layer of the metallic semifinished product is cohesively bonded to the metallic main body by magnetic pulse welding, soldering, roll cladding, ultrasound welding, friction welding and/or modifications thereof.

11. The method as claimed in claim 1, in which there is a final mechanical processing of the surface, at least of the friction surface, of the braking element.

12. A braking element having at least one metallic main body having a friction surface applied to a surface region formed, which is a prefabricated layer of a metallic semifinished product cohesively bonded to the metallic main body by joining methods.

13. The braking element as claimed in claim 12, in which at least one layer is composed of stainless steel, a metal matrix composite, ceramic matrix composite, cermet, cemented carbide, Glidcop and/or a material from the material class of the alum inides.

14. The braking element as claimed in claim 12, in which the friction surface has a layer thickness of 0.1 mm to 4.0 mm.

15. The braking element as claimed in claim 12, in which there is a joining zone composed of and/or between the metallic main body and the layer of the metallic semifinished product of between 1 μm and 50 μm.

16. The braking element as claimed in claim 12, in which the friction surface is formed from two or more layers.

17. The braking element as claimed in claim 12, in which the layers are composed of different materials, shapes and/or layer thicknesses.

18. The braking element as claimed in claim 12, in which at least one layer of the metallic semifinished product is formed from segments.

19. The braking element as claimed in claim 12, in which the segments are circular, oval, polygonal and/or freeform-shaped platelets.

20. The braking element as claimed in claim 12, in which at least the friction surface has wear recognition features.

21. The braking element as claimed in claim 20, in which the wear recognition features are surface depressions and/or color substances.
